(19) United States
(12) Patent Application Publication
(10) Pub. No.: US 2025/0113151 A1
(43) Pub. Date: Apr. 3, 2025

(54) Speaker comprising an electronic detection device for detecting a wall

(71) Applicant: DEVIALET, PARIS (FR)

(72) Inventors: Jean-Baptiste MEMBRADO, PARIS (FR); Nicolas LOPEZ ZULETA, MONTREUIL (FR)

(21) Appl. No.: 18/898,947

(22) Filed: Sep. 27, 2024

(30) Foreign Application Priority Data
Oct. 3, 2023 (FR) 2310553

(51) Int. Cl. H04R 29/00; G01P 15/00; H04R 1/40; H04R 3/00

(52) U.S. Cl. CPC H04R 29/001; H04R 1/406; H04R 3/005; G01P 15/00

(57) ABSTRACT

The present invention relates to a speaker (10) comprising:
at least one loudspeaker (20) able to emit an emitted audio signal,
a plurality of microphones (25) for acquiring a received audio signal, if a wall (15) is present in a speaker environment, the received audio signal comprising the audio signal reflected from the wall, and
an electronic detection device (30) for detecting a wall comprising a first calculation module (35) able to calculate a spectrogram of the directions of arrival of the received audio signal.

The detection device is characterized in that it further comprises:
a second calculation module (40) able to calculate an energy level of the audio signal received from each microphone, and
a determination module (45) able to determine the presence or absence of the wall in the speaker environment from a neural network model.

The present invention relates to a speaker comprising at least one loudspeaker able to emit an emitted audio signal, and a plurality of microphones each able to acquire an audio signal received by the speaker.

The present invention relates to the field of speakers, preferably portable speakers, also known as nomad speakers.

Such speakers are generally able to be positioned in different environments presenting different structures.

The acoustics of the sounds emitted by a speaker are strongly influenced by the environment, and in particular, by the presence of obstacles such as walls. Indeed, when the speaker is positioned close to a wall, for example less than 50 cm from it, the sounds emitted reflect off the wall and propagate to a user with a delay relative to sounds following a direct path between the speaker and the user.

This leads to a degraded experience for the speaker user.

There is therefore a need to determine the location of walls in the speaker environment in order to be able to adapt the signal emission from the speaker to limit the degradation of the user experience.

To this end, the invention has as its object a speaker further comprising at least one loudspeaker able to emit an emitted audio signal,
a plurality of microphones each able to acquire a received audio signal, if a wall is present in the speaker environment, the received audio signal comprising the emitted audio signal that has been reflected off the wall, and
an electronic detection device for detecting a wall connected to each microphone, the electronic detection device comprising:
   a first calculation module able to calculate a spectrogram of the directions of arrival of a component of the audio signal received by the speaker, from the received audio signal acquired by each of the microphones,
wherein the electronic detection device further comprises:
   a second calculation module able to calculate an energy level of the received audio signal acquired from each microphone, and
   a determination module able to determine the presence of a wall or the absence of a wall in the speaker environment by applying a neural network model to the spectrogram of the directions of arrival and to the determined energy levels.

According to particular embodiments, the speaker according to the invention comprises one or more of the following features, taken in isolation, or according to any technically possible combinations:
the neural network model comprises a first convolution neural network able to receive the spectrogram of the directions of arrival, a second neural network able to receive the energy levels, a concatenation block able to concatenate data from the first and second neural networks to form concatenated data, and a third neural network able to process the concatenated data to determine the presence or absence of the wall,
the first neural network comprises a circular sliding window and at least one layer of neurons, the sliding window being able to be applied to the spectrogram of the directions of arrival before the neural layer,
the neural network model is able, if the wall is present in the speaker environment, to determine a position of the wall relative to the speaker from among a plurality of predefined positions, from the spectrogram of the directions of arrival and the calculated energy levels,
at least one loudspeaker is able to emit the audio signal emitted according to a broadcast mode of the speaker,
the electronic detection device further comprises an adaptation module able to reconfigure the speaker broadcast mode as a function of the determination of the presence, or absence, of the wall,
the spectrogram of the directions of arrival is a matrix comprising a plurality of values, each value corresponding to the power of the audio signal received by the speaker according to a predefined angular interval relative to a predefined reference point centered on the speaker center, and according to a predefined frequency interval,
the transmitted audio signal is included in an audio stream coming from a broadcast instruction from a user; and
the speaker further comprises an accelerometer able to determine whether the speaker is stationary and to emit a calculation instruction when the speaker is stationary, the first and second calculation modules being able to calculate the spectrogram of the directions of arrival and energy levels following receipt of the calculation instruction from the accelerometer.

The invention also has as its object a method for detecting a wall in the speaker environment comprising at least one loudspeaker, several microphones and an electronic wall detection device connected to each microphone,
the method comprising the following steps:
emission of an audio signal by the at least one speaker,
acquisition, by each microphone, of a received audio signal, if the wall is present in a speaker environment, the received audio signal comprising the audio signal that has been reflected off the wall,
calculating a spectrogram of the directions of arrival of a component of the audio signal received by the speaker, from the received audio signal acquired by each microphone,
   characterized in that the method further comprises the following steps:
calculating an energy level of the received audio signal acquired from each microphone, and
determining the presence or absence of a wall in the speaker environment by applying a neural network model to the spectrogram of the directions of arrival and to the energy levels determined.

The invention also has as its object a computer program product comprising software instructions which, when executed by a computer, implement a detection method as described above.

The invention will become clearer on reading the following description, given solely by way of a non-limiting example, and made with reference to the drawings in which:

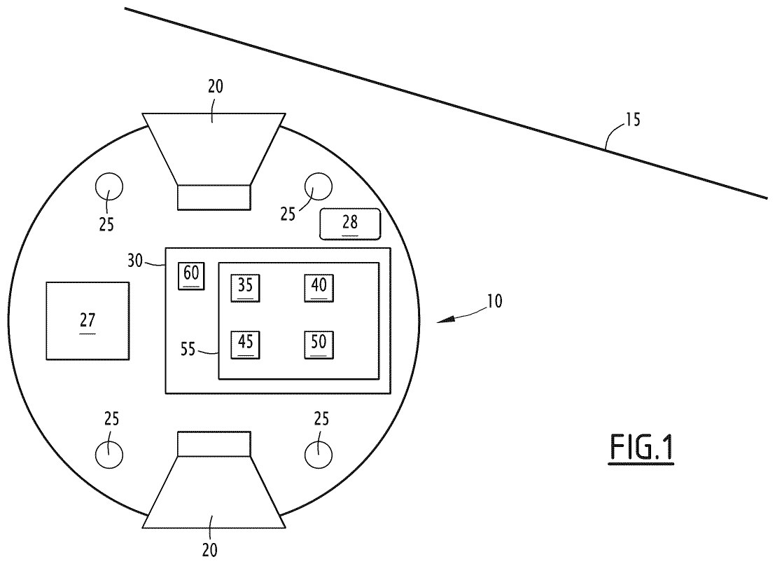

FIG. 1 is a schematic representation of a speaker according to the invention;

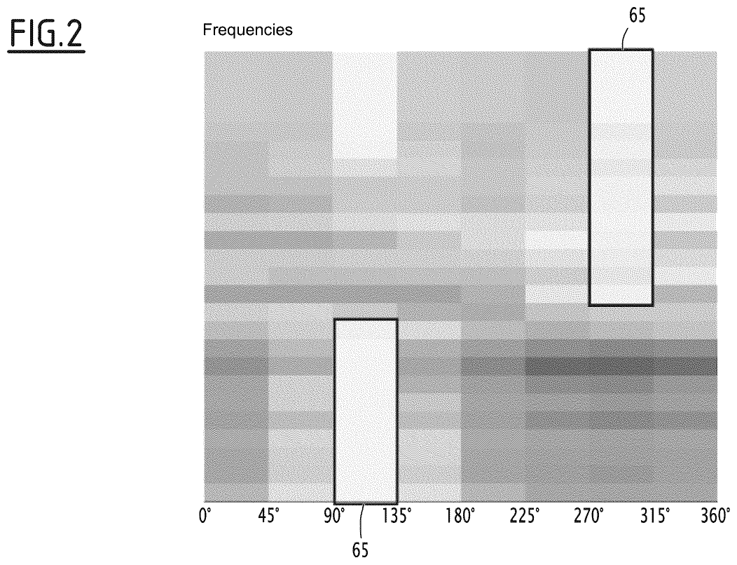

FIG. 2 is an example of a spectrogram of the directions of arrival able to be determined by an electronic detection device included in the speaker in FIG. 1;

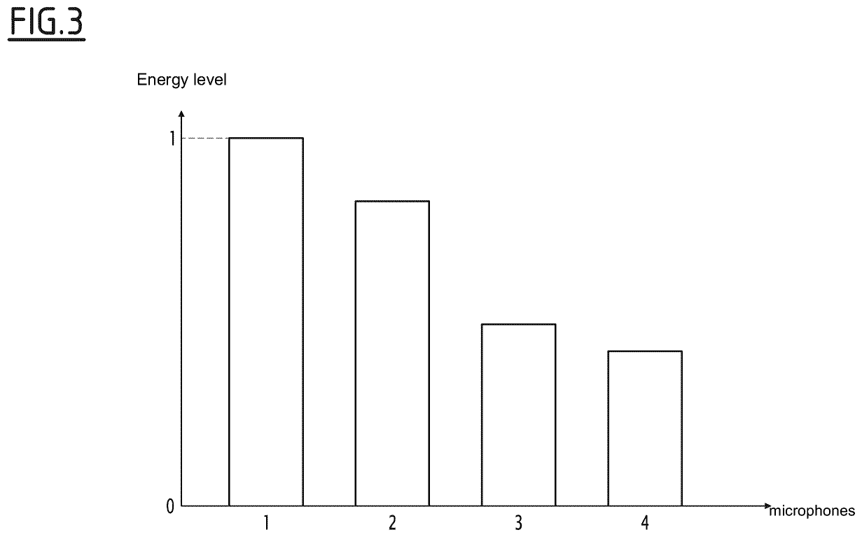

FIG. 3 is an example of the energy levels able to be determined by the electronic detection device included in the speaker in FIG. 1;

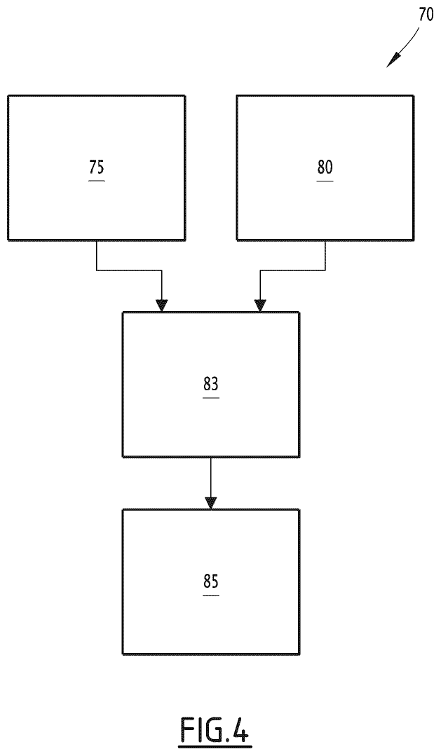

FIG. 4 is a schematic representation of a neural network model implemented by the electronic detection device included in FIG. 1; and

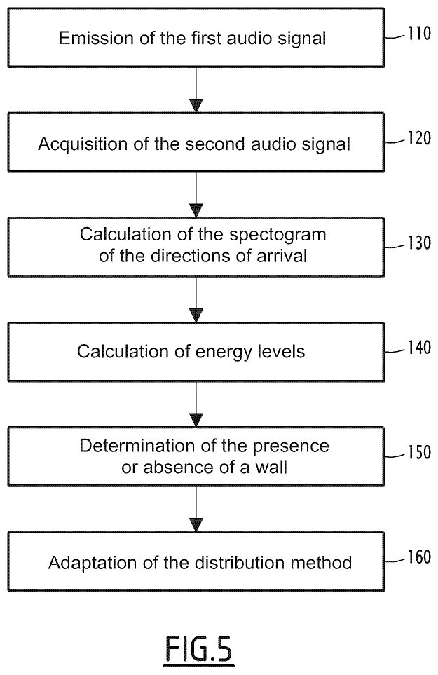

FIG. 5 is a flowchart of a detection method implemented by the speaker in FIG. 1.

In FIG. 1 is represented a speaker 10 in an environment. The environment comprises a wall 15 in the proximity of the speaker 10. “Proximity” means a distance of less than or equal to 1 m and preferably less than or equal to 50 cm.

The speaker 10 comprises at least one loudspeaker 20 able to emit audio signals. Preferably, the speaker 10 comprises several loudspeakers 20, preferably distributed about the periphery of the speaker 10 to emit audio signals in several directions.

In the example in FIG. 1, the speaker 10 comprises two loudspeakers 20.

The speaker 10 also comprises a plurality of microphones 25, each able to acquire the audio signals present in the speaker 10 environment. In the example in FIG. 1, the speaker 10 comprises four microphones distributed over the outer surface of the speaker 10. The microphones 25 are preferably evenly angularly spaced from one another. Thus, in the example where the speaker 10 comprises four microphones 25, the microphones 25 are angularly distributed with an angular displacement equal to 90° so as to acquire audio signals in directions as far apart from each other as possible.

The speaker 10 also comprises a control device 27, an accelerometer 28 and an electronic detection device 30. The control device 27 is connected to the loudspeakers 20 and optionally to an audio content source, not shown, such as a digital player, an optical disc player, a vinyl disc player or a smartphone. The control device 27 is able to receive audio content from the source, and to send an excitation control to the loudspeakers 20 to play the received audio content. The excitation control then causes the loudspeakers 20 to emit an audio signal, referred to as the transmitted audio signal. Preferably, the control device 27 is able to send the excitation control according to a first broadcasting mode of the speaker 10 chosen from several predefined broadcasting modes of the speaker 10. For example, the chosen broadcast mode is a neutral mode in which the loudspeakers 20 are controlled in a synchronous manner.

It is then understood that the audio signal emitted is included in an audio stream coming from a broadcast instruction from a user. In other words, the audio signal emitted is, for example, any type of music or voice, and is not limited to a predefined test signal.

If the wall 15 is present in the speaker 10 environment, the emitted audio signal is at least partially reflected off the wall 15.

Each microphone 25 is then able to acquire an audio signal received by the speaker 10 following the emission of the audio signal emitted by the loudspeakers 20.

The audio signal received comprises a direct component, which is the audio signal emitted according to the direct path between the loudspeakers 20 and the microphones 25.

If the wall 15 is present in the speaker 10 environment, as in the example in FIG. 1, the received audio signal also comprises a reflected component, which is the audio signal emitted and reflected on the wall 15.

Optionally, the received audio signal also comprises noise. In other words, the received audio signal comprises:
the direct component and noise, if no wall 15 is present in the speaker 10 environment; or
the direct component, the reflected component, and noise, if the wall 15 is present in the speaker 10 environment.

The accelerometer 28 is connected to the detection device 30. The accelerometer 28 is able to measure an acceleration of the speaker 10 and to send a calculation instruction to the detection device 30 when the speaker 10 is stationary once more.

The electronic detection device 30 comprises a first module 35 for calculating a spectrogram of the directions of arrival, a second module 40 for calculating energy levels, a module 45 for determining the presence or absence of the wall 15, and optionally a module 50 for adapting a scattering mode.

In the example in FIG. 1, the electronic detection device 30 is a computer consisting, for example, of a memory 55 and a processor 60 associated with the memory 55.

In the example in FIG. 1, the first calculation module 35, the second calculation module 40 and the determination module 45, as well as an optional addition, the adaptation module 50, are each realized in the form of software, or a software brick, executable by the processor. The memory 55 of the electronic detection device 25 is then able to store a first calculation software, a second calculation software, and a determination software, as well as an optional addition, an adaptation software. The processor is then able to execute each of the first calculation software, the second calculation software, and the detection software, as well as an optional addition, the adaptation software.

As an alternative, not shown, the first calculation module 35, the second calculation module 40 and the determination module 45, as well as an optional addition the adaptation module 50, are each realized in the form of a programmable logic component, such as an FPGA (Field Programmable Gate Array), or an integrated circuit, such as an ASIC (Application Specific Integrated Circuit).

When the electronic detection device 30 is realized in the form of one or more software programs, in other words, in the form of a computer program, also known as a computer program product, it is also able to be recorded on a computer-readable medium (not shown). The computer-readable medium is, for example, a medium capable of storing electronic instructions and of being coupled to a bus of a computer system. By way of example, the readable medium is an optical disk, a magneto-optical disk, a ROM memory, a RAM memory, any type of non-volatile memory (for example, FLASH or NVRAM) or a magnetic card. A computer program comprising software instructions is then stored on the readable medium.

The control device 27 is also, for example, a computer comprising a memory, not shown, and a processor, not shown.

Alternatively, the detection device 30 and the control device 27 form a single computer comprising a single processor 60 and a single memory 55. The memory 55 then also stores control software.

The first calculation module 35 is able to acquire the audio signal received from each microphone 25, for example, following reception of the calculation instruction from the accelerometer 28. The first calculation module 35 is able to calculate a spectrogram of the directions of arrival of the received signal on the speaker 10, from the audio signal received by the speaker 10 and acquired by each of the microphones 25. The spectrogram of the directions of arrival is calculated from all the components of the received audio signal.

For this purpose, the first calculation module 35 is able, for example, to apply the MUSIC (MUltiple SIgnal Classification) algorithm known from the state of the art and described in particular on the following web page https://fr.wikipedia.org/wiki/MUSIC_(algorithm). In a manner known per se, the MUSIC algorithm is configured to detect a sound signal coming from a search direction. When it detects a sound signal coming from a particular direction, it is necessarily the reflected component because, by construction, the direct component arrives in an identical manner according to all directions.

Using the MUSIC algorithm, then allows to identify a preferred direction of arrival for the audio signal received.

If the wall 15 is present in the speaker 10 environment, the component identified corresponds substantially to the reflected component of the received audio signal.

The MUSIC algorithm provides a matrix.

The columns of this matrix represent the directions of arrival about the speaker 10 according to a first sampling of directions of arrival. The columns therefore correspond to an angular interval of identical width from one column to another, in a predefined reference frame centered on a center of the speaker 10.

The rows of this matrix correspond to frequency bins. For example, the matrix comprises 257 rows.

Each value of the matrix is associated with a column and a row and corresponds to the power of the component identified by the MUSIC algorithm, in the angular interval of the associated column, and for the frequency interval of the associated row.

The first calculation module 35 is also optionally able to perform frequency sub-sampling and smoothing in sixths of an octave on the frequency axis of the matrix to reduce the number of rows, for example to 25 rows. Alternatively, smoothing can be realized in twelfths of an octave, in thirds of an octave or per octave.

In addition, the first calculation module 35 is optionally able to reduce the number of columns by averaging the values over several angular intervals, for example so that the matrix comprises only 8 columns. In other words, after averaging, each column corresponds to an angular interval of 45°.

In addition, the first calculation module 35 is preferably able to normalize the values of the matrix obtained so that the highest value corresponds to the value 1 and the other values correspond to percentages of the highest value.

Thus, the direction(s) of arrival for which the values are highest are the most likely directions of arrival on the speaker 10 of the reflected component. Thus, this direction or these directions of arrival are the most probable directions in which the wall 15 is located relative to the speaker 10.

The matrix obtained by the first calculation module 35 is then the spectrogram of the directions of arrival of the sound sources about the speaker 10, including in particular, the reflected component identified when it is present. An example of such a spectrogram is shown in FIG. 2 in grayscale. In FIG. 2, each box corresponds to a value in the matrix obtained.

In FIG. 2, the brighter the box, the higher the power of the identified reflected component on the speaker 10 in the corresponding frequency and angular range. Conversely, the darker the box, the lower the power of the identified reflected component in the corresponding frequency and angular range.

FIG. 2 shows two zones 65. The zones 65 correspond to sets of frequency intervals for which the power of the identified reflected component is the highest.

In the example in FIG. 2, these zones correspond to angular intervals between 90° and 135° on the one hand, and between 270° and 315° on the other. There is therefore a 180° ambiguity concerning the direction of the wall 15 relative to the speaker 10. This ambiguity results from the fact that the MUSIC algorithm is intended to calculate a spectrogram of the directions of arrival in the context of a point source and not of a reflection of an audio signal on a surface formed by the wall 15.

In addition, the material of the wall 15 has an influence on the frequency of the reflection of the emitted audio signal. Indeed, according to the material of the wall 15, certain frequencies are predominantly absorbed, while others are predominantly reflected.

The second calculation module 40 is also able to receive the audio signal from each microphone 25, for example following reception of the calculation instruction from the accelerometer 28.

The second calculation module 40 is able to calculate an energy level of the received audio signal, acquired from each microphone 25.

To this end, the second calculation module 40 is able to calculate the energy level of the received audio signal acquired by each microphone 25 for a predefined duration, for example 5 seconds. Preferably, the calculation module 40 is able to calculate energy levels only over a predefined frequency band, for example between 20 Hz and 20,000 Hz.

For example, the energy level is calculated using the following formula:

$${E}_{i} = {\sum }_{t ∈ [ 0 , T ]} {\sum }_{f ∈ [ {f}_{min} , {f}_{max} ]} \frac{{X}_{i} ( t , f ) . conj ( {X}_{i} ( t , f )}{T \cdot ( {f}_{max} - {f}_{min} )}$$

where: Eᵢ is the energy level received by the microphone i,
T is the predefined duration,
fₘᵢₙ and fₘₐₓ are respectively the minimum and maximum frequencies of the frequency band,
Xᵢ(t,f) is the audio signal received by the microphone i at time t and frequency f, in the frequency domain, and
conj(·) is the complex conjugate function.

The second calculation module 40 is able to normalize the energy levels so that the highest energy level is equal to 1 and the other energy levels are equal to percentages of the highest energy level.

FIG. 3 shows an example of calculated energy levels. It can be seen from FIG. 3 that the first microphone 25 acquires the received audio signal with the highest energy level, that is, a normalized level equal to 1. It can also be seen that the other microphones 25 acquire the received audio signal with a lower energy level, that is, a normalized level between 0 and 1.

Again, with reference to FIG. 1, the determination module 45 is connected to the first 35 and second 40 calculation modules.

The determination module 45 is able to determine the presence of the wall 15 or the absence of the wall 15 in the speaker 10 environment by applying a neural network model 70 to the spectrogram of the directions of arrival and to the energy levels determined.

FIG. 4 illustrates the architecture of the neural network model 70 implemented by the determination module 45.

The neural network model 70 comprises a first convolutional neural network 75 able to receive the spectrogram of the directions of arrival, a second neural network 80 able to receive the energy levels, a concatenation block 83 intended to concatenate data from the first 75 and the second 80 neural networks to form concatenated data, and a third neural network 85 able to process the concatenated data to determine the presence or absence of the wall 15.

Each neural network includes an ordered succession of neural layers, each of which takes its inputs from the outputs of the preceding layer.

More precisely, each layer comprises neurons taking their inputs from the outputs of the neurons in the previous layer, or even from the input variables for the first layer.

Each neuron is also associated with an operation, in other words, a type of processing, to be performed by said neuron within the corresponding processing layer.

Each layer is linked to other layers by a plurality of synapses. A synaptic weight is associated with each synapse, and each synapse forms a link between two neurons. Each synaptic weight is preferably a real number, which takes on both positive and negative values. In some cases, each synaptic weight is a complex number.

Each neuron is able to perform a weighted sum of the value(s) received from the neurons of the preceding layer, each value then being multiplied by the respective synaptic weight of each synapse, or link, between said neuron and the neurons of the preceding layer, then to apply an activation function, typically a non-linear function, to said weighted sum, and to deliver at the output of said neuron, in particular to the neurons of the following layer which are connected to it, the value resulting from the application of the activation function. The activation function allows non-linearity to be introduced into the processing performed by each neuron. The sigmoid function, the hyperbolic tangent function, the Heaviside function, the Rectified Linear Unit (ReLU) function or the SoftMax function are examples of activation function.

As an optional addition, each neuron is also able to apply a multiplicative factor, also known as bias, to the output of the activation function, and the value delivered on output by said neuron is then the product of the bias value and the value from the activation function.

A convolutional neural network is also sometimes referred to as a convolutional neural network (CNN).

In a convolutional neural network, each neuron in the same layer presents exactly the same connection pattern as its neighboring neurons, but at different input positions. The connection pattern is called a convolution kernel.

A fully connected neuron layer is one in which the neurons of said layer are each connected to all the neurons of the preceding layer.

This type of layer is more often referred to as a “fully connected” layer and is sometimes referred to as a “dense layer”.

The first neural network 75 comprises a circular sliding window (circular padding) and at least one neural layer. Preferably, the first neural network 75 comprises three layers of neurons.

The sliding window comprises a kernel of width M and height N, M being less than the number of columns in the matrix forming the spectrogram, N being less than the number of rows in said matrix. The window is able to move in the spectrogram to form sub-matrices of dimensions M by N. The sub-matrices are supplied to the at least one neural layer.

The circular type of the sliding window is such that the window is able to form sub-matrices comprising values from the first column and the last column. In other words, the sliding window moves over the spectrogram as if the first column of the corresponding matrix were contiguous with the last column, that is, as if the spectrogram formed a cylinder.

The sliding window is able to be applied to the spectrogram of the directions of arrival, calculated by the first calculation module 35, before the or each layer of neurons.

Thus, the spectrogram of the directions of arrival is processed as an image by the first neural network 75.

The first neural network 75 provides, as its output, the first data.

The second neural network 80 is a fully connected type of neural network. The second neural network 80 is able to take as input a vector comprising the normalized energy level of each microphone 25 calculated by the second calculation module 40.

The second neural network 80 provides, at its output, second data.

The concatenation block 83 is connected to the output of the first 75 and second 80 neural networks and is able to concatenate the first and second data into a single vector to form the concatenated data.

The third neural network 85 is connected to the concatenation block 83. The third neural network 85 is, for example, of the fully connected type.

The third neural network 85 is preferably able to classify the concatenated data from among a plurality of classes, for example nine classes.

For example, all but one class corresponds to a predefined position of the wall 15 relative to the speaker 10, the last class corresponds to the absence of the wall 15. The position of the wall 15 is defined here as the direction in which the wall 15 is located relative to the speaker 10 in a predefined reference frame centered on the speaker 10. Thus, each class corresponds to a predefined position of the wall 15, defined by an angular interval in which the wall 15 is located relative to the speaker 10.

If the plurality of classes comprises nine classes, each of the first eight classes corresponds to an angular interval of 45°, with the ninth class corresponding to the absence of the wall 15.

To this end, the third neural network 85 is able to provide at its output, an output vector comprising nine components. The activation function of the neurons in the last layer of the third neural network 85 is preferably the SoftMax function. Thus, the value of each component of the output vector is between 0 and 1, and the sum of the values of all the components of said vector is equal to 1. The value of each component is then a probability of belonging to the corresponding class.

For example, the determination module 45 is able to determine the absence of the wall 15 if the component of the output vector with the highest value is the component associated with the class corresponding to the absence of the wall 15. The determination module 45 is then able to determine the presence of the wall 15 otherwise.

As an optional addition, the determination module 45 is further able to determine the position of the wall 15 as being the position defined by the class the output component of which has the highest value in the output vector.

Optionally, the determination module 45 is configured to compare said highest value with a predefined threshold. If the highest value is lower than the predefined threshold, then the determination module 45 is able to determine that the detection of the wall 15 is inconclusive and to order the reiteration of the calculations by the first 35 and second 40 calculation modules on the basis of second audio signals acquired at a later time.

The adaptation module 50 is able to receive the position of the wall 15, or information on the absence of the wall 15, from the determination module 45.

The adaptation module 50 is able to reconfigure the broadcasting mode of the speaker 10 as a function of the determination of the presence or absence of the wall 15, and more preferably as a function of the position of said wall 15 if applicable.

In the example in FIG. 1, a diffusion mode is associated with each of the following positions of the wall 15: facing one of the loudspeakers 20, facing the other loudspeaker 20, at 90° to a line joining the two loudspeakers 20 in one direction, and at 90° to the line joining the two loudspeakers 20 in the opposite direction. Thus, four broadcast modes are defined by these positions.

For each of these four broadcast modes, a delay is applied by the control device 27 to one of the loudspeakers 20, for example, to compensate for the presence of the wall 15.

A fifth broadcast mode is defined as a neutral broadcast mode in which the loudspeakers 20 are controlled synchronously, that is, without delay. The adaptation module 50 is, for example, able to associate the fifth broadcast mode with all other positions and with the determination of the absence of the wall 15.

In the fifth broadcast mode, the different channels are preferably equalized in phase and amplitude.

In the first, second, third and fourth broadcast modes, further processing is also preferably performed to further improve sound rendering for a user located opposite the wall relative to the speaker 10. For example, this processing includes phase and amplitude equalization, and signal decomposition into components to be broadcast to the front and rear of the speaker 10.

The adaptation module 50 is adapted to send the reconfigured broadcast mode to the control device 27 so that it controls the loudspeakers 20 in accordance with this reconfigured broadcast mode.

The operation of the speaker 10 will now be described with reference to FIG. 5 illustrating a flowchart of a method for determining the presence or absence of the wall 15.

During a transmission step 110, the control device 27 receives audio content from the source and sends an excitation control to the loudspeakers 20 to transmit the audio content.

At some point, the accelerometer 28 detects that the speaker has become motionless after moving. The accelerometer then sends an instruction to the detection device 30 indicating that the speaker 10 has become motionless. The audio content emitted by the loudspeakers 20 from this moment onwards is the audio signal emitted.

During an acquisition step 120, each microphone 25 acquires the audio signal received.

Then, during a first calculation step 130, the first calculation module 35 calculates the spectrogram of the directions of arrival of the audio signal component received by the speaker 10, from the received audio signal acquired by each of the microphones 25, for example as described above.

During a second calculation step 140, the second calculation module 40 calculates the energy level of the received audio signal, acquired from each microphone 25, for example as previously explained.

Preferably, the first 130 and second 140 calculation steps are carried out simultaneously.

Then, during a determination step 150, the determination module 45 determines the presence of the wall 15 or the absence of the wall 15 in the speaker 10 environment, by applying the neural network model 70 to the spectrogram of the directions of arrival and to the calculated energy levels.

For example, the determination module 45 applies the first neural network 75 to the spectrogram to obtain the first data and the second neural network 80 to the energy levels to obtain the second data. The determination module 45 then applies the concatenation block 83 to the first and second data to form the concatenated data. The determination module 45 then provides the concatenated data to the third neural network 85 to determine the output vector.

According to this optional addition, the determination module 45 determines the position of the wall 15 relative to the speaker 10 or the absence of the wall 15, as previously indicated, from the output vector.

Optionally, during an adaptation step 160, the adaptation module 50 reconfigures the broadcast mode of the speaker 10 as a function of the position of the wall 15 relative to the speaker 10, or the absence of the wall 15, for example by sending the reconfigured broadcast mode to the control device 27.

With the speaker 10 according to the invention, the presence of the wall 15, or its absence, is accurately detected.

1. A speaker comprising:
at least one loudspeaker able to emit an emitted audio signal,
a plurality of microphones each able to acquire a received audio signal,
if a wall is present in a speaker environment, the received audio signal comprises the emitted audio signal that has been reflected off the wall, and
an electronic detection device of the wall connected to each microphone,
the electronic detection device comprising:
a first calculation module able to calculate a spectrogram of the directions of arrival of the audio signal received by the speaker, from the received audio signal acquired by each of the microphones,
characterized in that the electronic detection device further comprises:
a second calculation module able to calculate an energy level of the received audio signal acquired from each microphone, and
a determination module able to determine the presence of the wall or the absence of the wall in the speaker environment by applying a neural network model to the spectrogram of the directions of arrival and to the determined energy levels.

2. The speaker according to claim 1, wherein the neural network model comprises a first convolutional neural network able to receive the spectrogram of the directions of arrival, a second neural network able to receive the energy levels, a concatenation block able to concatenate the data from the first and second neural networks to form concatenated data, and a third neural network able to process the concatenated data to determine the presence or absence of the wall.

3. The speaker according to claim 2, wherein the first neural network comprises a circular type sliding window and at least one neural layer, the sliding window being able to be applied to the spectrogram of the directions of arrival before the neural layer.

4. The speaker according to claim 1, wherein the neural network model is able, if the wall is present in the speaker environment, to determine a position of the wall relative to the speaker from among a plurality of predefined positions, from the spectrogram of the directions of arrival and the calculated energy levels.

5. The speaker according to claim 1, wherein the at least one loudspeaker is able to emit the audio signal emitted according to a broadcast mode of the speaker,
the electronic detection device further comprising an adaptation module able to reconfigure the broadcast mode of the speaker as a function of determining the presence, or absence, of the wall.

6. The speaker according to claim 1, wherein the spectrogram of the directions of arrival is a matrix comprising a plurality of values, each value corresponding to the power of the audio signal received by the speaker according to a predefined angular interval relative to a predefined reference frame centered on a center of the speaker, and according to a predefined frequency interval.

7. The speaker according to claim 1, wherein the emitted audio signal is included in an audio stream from a broadcast instruction from a user.

8. The speaker according to claim 1, further comprising an accelerometer able to determine whether the speaker is stationary and to emit a calculation instruction when the speaker is stationary, the first and second calculation modules being able to calculate the spectrogram of the directions of arrival and energy levels following receipt of the calculation instruction from the accelerometer.

9. A method for detecting a wall in a speaker environment comprising at least one loudspeaker, a plurality of microphones and an electronic device for detecting the wall connected to each microphone,
the method comprising the following steps:
emission of an audio signal emitted by the at least one,
acquisition, by each microphone, of a received audio signal,
if the wall is present in a speaker environment, the received audio signal comprising the audio signal that has been reflected on the wall,
calculating a spectrogram of the directions of arrival of the audio signal received by the speaker, from the received audio signal acquired by each microphone,
wherein the method further comprises the following steps:
calculating an energy level of the received audio signal acquired from each microphone, and
determining the presence of the wall or the absence of the wall in the speaker environment by applying a neural network model to the spectrogram of the directions of arrival and to the energy levels determined.

10. A computer program product comprising software instructions which, when executed by a computer, implement a detection method according to claim 9.
